(19) United States
(12) Patent Application Publication
(10) Pub. No.: US 2012/0286992 A1
(43) Pub. Date: Nov. 15, 2012

(54) INDOOR POSITIONING SYSTEM BASED ON GPS SIGNALS AND PSEUDOLITES WITH OUTDOOR DIRECTIONAL ANTENNAS

(76) Inventors: Ibrahim Tekin, Istanbul (TR); Ayhan Bozkurt, Istanbul (TR); Kerem Ozsoy, Istanbul (TR)

(21) Appl. No.: 13/520,179

(22) PCT Filed: Dec. 31, 2009
(86) PCT No.: PCT/IB09/56002

§ 371 Date: Jun. 29, 2012

(51) Int. Cl. G01S 19/11

(52) U.S. Cl. 342/357.48

(57) ABSTRACT

This invention comprises at least three directional GPS antennas (2) for picking up specific GPS signals conning from at least three GPS satellites (S), at least three RF GPS repeaters (3) for amplifying GPS signals coming from directional GPS antennas (2), at least three GPS antennas (6) for transmitting GPS signals coming from RF GPS repeaters (3) to indoor, at least one GPS receiver (7) for picking up GPS signals coming from GPS antennas (6) by its (7) antenna (8) novel position calculation method (100) and relates to increase the coverage of the outdoors GPS signals to indoors.

### FIELD OF THE INVENTION

This invention relates to an indoor positioning system based on GPS (Global Positioning System) signals for increasing the coverage of the outdoors GPS signals to indoors.

### PRIOR ART

The GPS is a radio navigation system which provides accurate and reliable positioning, navigation, and timing services freely available to civilian population. The GPS provides location information and accurate time for anybody who has a GPS receiver. The GPS provides location and time information at all time, anywhere on the world.

The GPS system consists of 24 operational GPS satellites rotating around the earth twice a day at an altitude of approximately 20200 km, controlling and monitoring stations on the network side as well as GPS receivers on the user side. GPS satellites transmit RF signals at a frequency of 1575.42 MHz from the space and GPS receivers pick up these RF signals and down convert to an intermediate frequency (IF) for correlation and further baseband processing. The GPS receivers perform correlation of the down converted signal with a locally generated replica and measure the so called the pseudo ranges between the GPS satellite and the GPS receiver. The pseudo range is the actual distance between the GPS satellite and the GPS receiver if the GPS receiver is synchronized with the GPS time. However, initially the GPS receiver has a clock offset from the GPS time and this clock offset is seen on the pseudo range measurement. After obtaining the pseudo ranges for at least four GPS satellites, the GPS receiver provides the location of itself and the GPS time.

GPS receivers improve the quality of daily life by providing affordable means for precision tracking and navigation outdoors. There are also some indoor positioning applications that the use of GPS can be of great help. A firefighter trying to extinguish the fire in a building, or a patient trying to find his way in a hospital, or a person waiting alive to be rescued after an earthquake are some typical examples for indoor applications.

The GPS signals come from a distance of 20200 km and their signal levels are barely enough for a GPS receiver to perform detection and estimation of pseudo ranges and the messages on the GPS signals in an open sky. However, due to additional losses (which are approximately 20-30 dBs) a conventional GPS receiver cannot detect the GPS signals within a building, tunnel, mine or under a debris.

One way to increase the GPS signal levels in closed spaces is to use active RF GPS repeaters. An active GPS repeater picks up the GPS signal from outdoors with a GPS antenna and after filtering and amplification, GPS repeater reradiates the GPS signal with another GPS antenna to locations where the GPS signal level is too low for positioning. Indoor positioning requires the deployment of multiple GPS repeaters: at least three repeaters for 2D (two dimensional), and four repeaters for 3D (three dimensional) positioning are required. However, one must be very careful when amplifying multiple GPS signals. Picking up multiple GPS signals at multiple antennas and then reradiating the same GPS signals from different antennas cause signal interference. This decreases the GPS signal's coverage as well as increases the error in positioning. To eliminate the interference problem, repeaters and their antennas should be designed such that a specific GPS signal can be picked up by only one repeater. A repeater can pick up many different GPS signals; however, no other repeaters should be receiving a GPS signal that has received by another repeater. In other words, the set of GPS signals received by the repeaters should be mutually exclusive. For example; Repeater 1: GPS satellites 2, 4 and 5, Repeater 2: GPS satellites 3, 6 and 9, Repeater 3: 15, 16 and 17 etc.

Another point which is very critical in positioning indoors is the use of GPS algorithms for calculation of the position from the pseudo range measurements. If a conventional GPS receiver with unmodified algorithms is used, then the calculated position becomes erroneous. If the active RF repeaters are placed to a building to enhance the coverage of the GPS signals indoors and a conventional GPS receiver is used to calculate its location, due to non line of sight (NLOS) propagation of the RF waves from the GPS satellite to the GPS receiver, the calculated position can be the incorrect position with large error. A 2D positioning example can be seen in the FIG. 3 where M1, M2 and M3 are GPS satellite locations; and N1, N2 and N3 are the RF GPS repeater locations. “A” is the actual location of the GPS receiver. If there is no clock offset at GPS receiver at “A” and time delay values of RF GPS repeaters are calibrated, conventional GPS algorithms search for the intersection of Line 1, Line 2 and Line 3 and yield a position in triangular region “D” even for the case of no pseudo range measurement error. Hence, to calculate position indoors accurately, one also has to modify the algorithms for positioning.

In the American Patent no. US2006208946, an indoor GPS repeater unit comprises a directional receive aerial for receiving GPS signals from one or more GPS satellites in a preselected area of the sky, a transmitting aerial for transmitting the received GPS signals; and RF amplification means for enhancing the received GPS signals before transmitting into an indoor area. One or more such GPS repeater units are used to reproduce the GPS satellite constellation within buildings or underground to provide GPS coverage in these environments. Nothing is mentioned about the algorithms in this application. After repeating the GPS signals, additional indoor positioning algorithms should be applied to calculate position of the GPS receiver. If the positioning algorithms are not modified, the calculated position can not be correct.

In the Chinese Patent no. CN1776447, the GPS signal covering equipment includes GPS signal source, antenna, filter, amplifier and indoors covering system. In order to introduce GPS signal source, the installed outdoor receiving antenna is connected to filter, amplifier and the indoors covering system in sequence. The invention magnifies GPS signal for the covered place, where GPS signal is needed. Nothing is mentioned about the algorithms in this application. After repeating the GPS signals, additional indoor positioning algorithms should be applied to calculate position of the GPS receiver. If the positioning algorithms are not modified, the calculated position can not be correct.

In the Korean Patent no. KR20080060502, an indoor measuring system using a GPS switching repeater includes a GPS satellite, a GPS reference antenna, a GPS switching repeater, a GPS transmission antenna, an indoor GPS receiver, and a measurement server. The GPS reference antenna receives the distance information from the GPS satellite. The GPS switching repeater adjusts a GPS switching time. Adding to this, the GPS switching repeater amplifies a GPS signal. The GPS transmission antenna is coupled to the GPS switching repeater and is installed on a wall or ceiling to transmit the GPS signal to the GPS repeater. The indoor GPS receiver measures a signal transmitted from the GPS switching repeater through the GPS transmission antenna, and calculates the distance between the GPS transmission antenna and the indoor GPS receiver. The measurement server estimates the position of the indoor GPS receiver by applying a value measured in the GPS transmission antenna and the GPS switching repeater to measurement algorithm. In this invention there is no any information about directional antennas.

In the American Patent no. US2003066345, a system comprises a plurality of transmitting units placed throughout a service area. Each transmitting unit repeatedly transmits a signal including position information related to a position associated with the transmitting unit. A receiving unit receives the signal transmitted from a transmitting unit and determines the position of the receiving unit, based on the received indication. The transmitting units are placed to provide uniform coverage of the service area, thus providing position location indoors and in urban areas where GPS does not function properly. US2003066345 discloses a system and method for automated position location using RF signposting. This application is about location finding by using RF signals. In this invention, there is no any information about GPS systems.

There has been an extensive research effort to find location indoors, and there are positioning prototype systems by utilizing different RF technologies. Some of these RF technologies use newly installed RF infrastructure within the buildings and some of these systems use already available RF infrastructure to find position. For example, ultra wide band microwave systems are employed in [1] for an asset location system, and some of these location finding techniques based on newly installed equipments are summarized in [2]. These systems use their own hardware for positioning and hence obtain highly accurate positions. However, deployments of these systems are complex and quite expensive. There are also examples of the RF positioning systems using the already available infrastructure such as WLAN [3], Bluetooth [4], RFID [5] or GSM [6]. Since all these systems are deployed mostly for communication purposes, most of them have shortcomings in either positioning accuracy or in the coverage. Finally, there are systems which repeat the GPS signal indoors by using antennas and amplifiers as in specified in patent application in [7]. In this application, the technique is only specified in terms of receiving the GPS signals from the parts of the sky and after amplification, the signals are reradiated indoors. This technique suffers from the non-direct propagation of the RF signals from the GPS satellite to RF repeater and then RF repeater to RF GPS receiver. In the application, there is no any specification for the algorithms that is used in the GPS receiver.

### SUMMARY OF THE INVENTION

The object of the invention is to provide an indoor positioning system which increases the coverage of the outdoors GPS signals to indoors.

Further object of the invention is to provide an indoor positioning system which has the positioning accuracy same as the outdoor positioning accuracy of GPS.

### BRIEF DESCRIPTION OF THE DRAWINGS

“An Indoor Positioning System” designed to fulfill the objects of the present invention is illustrated in the attached figures, where:

FIG. 1—is the schematic view of the indoor positioning system.

FIG. 2—is the schematic view of the RF GPS repeater with directional GPS antennas and GPS antenna.

FIG. 3—is the non line of sight propagation for 2D indoor GPS example.

FIG. 4—is the schematic view of the directional GPS antenna.

FIG. 5—is the graphical illustration of the measured return loss of the GPS antenna, simulated return loss of the directional GPS antenna and measured return loss of the directional GPS antenna versus frequency.

FIG. 6—is the graphical illustration of the simulated and measured radiation patterns of the GPS antenna and directional GPS antenna, respectively.

FIG. 7—is the graphical illustration of the measured radiation patterns of the directional GPS antenna in Phi (φ)=0 and Phi (φ)=90 degree planes.

FIG. 8—is the graphical illustration of the GPS receiver's position calculation method.

FIG. 9—is the graphical illustration of the distribution of the GPS receiver in the “distance”—“number of occurrence” plane.

FIG. 10—is the graphical illustration of the GPS receiver's calculated position and GPS receiver's real position in the “distance”—“number of try” plane.

### LIST OF REFERENCE SYMBOLS

1 Indoor positioning system
2, 2a, 2b, 2c Directional GPS antenna
3, 3a, 3b, 3c RF GPS repeater
4 Band pass filter
5 Low noise amplifier
6, 6a, 6b, 6c GPS antenna
7 GPS receiver
8 GPS receiver's antenna
100 Position calculation method
S, S1, S2, S3, S4,
S5, S6, S7, S8 GPS satellites
T Transmission line
B Building
P Ground plate
C Conical floating reflector
R1, R2, R3 Distance from GPS satellite to the RF GPS repeater
R3, R4, R5 Distance from RF GPS repeater to the GPS receiver
M1, M2, M3 GPS satellite location
N1, N2, N3 RF GPS receiver location

### DETAILED DESCRIPTION OF THE INVENTION

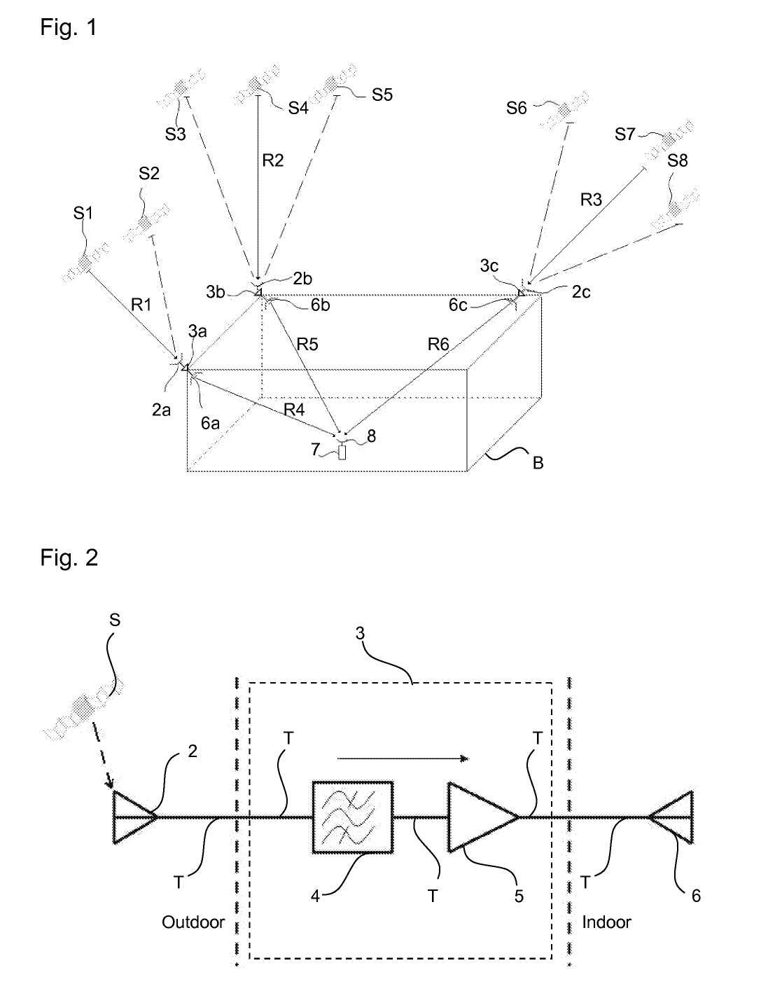

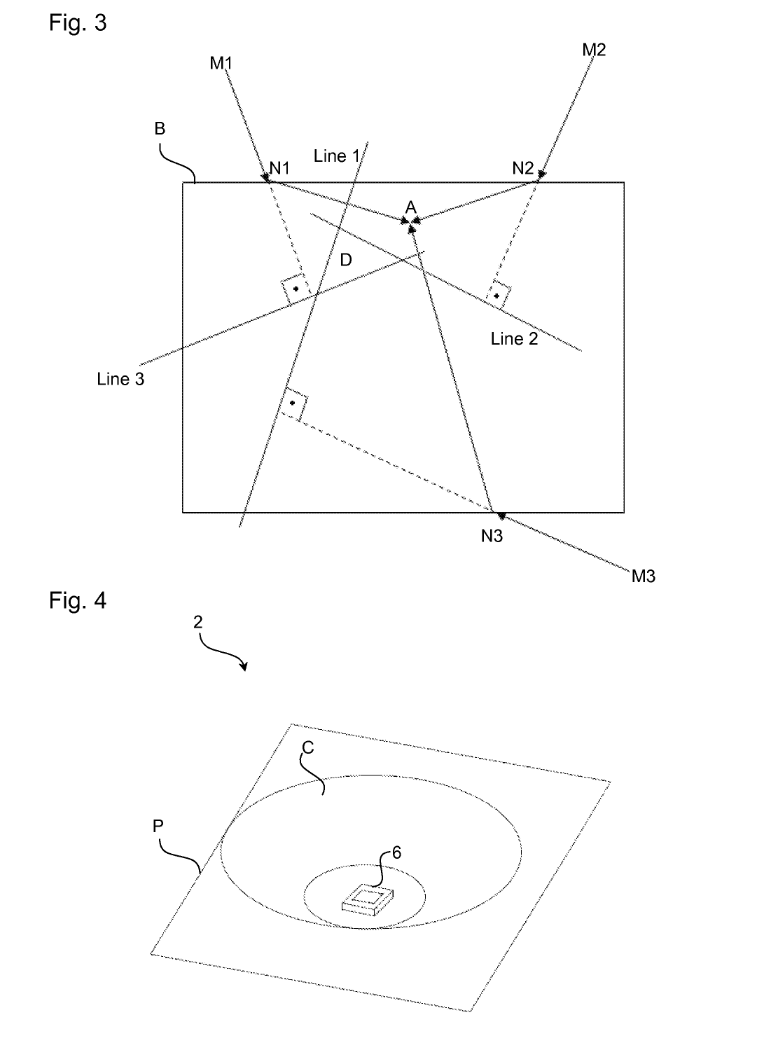

Referring to FIG. 1, the indoor positioning system (1) comprises at least three directional GPS antennas (2a, 2b and 2c) for picking up specific GPS signals coming from at least three GPS satellites (S1, S4 and S7), at least three RF GPS repeaters (3a, 3b and 3c) for amplifying GPS signals coming from directional GPS antennas (2a, 2b and 2c), at least three GPS antennas (6a, 6b and 6c) for transmitting GPS signals coming from RF GPS repeaters (3a, 3b and 3c) to indoor, at least one GPS receiver (7) for picking up GPS signals coming from GPS antennas (6a, 6b and 6c) by its (7) antenna (8) and position calculation method (100) for calculating the GPS time and finding positioning in two dimensions.

If there are three RF GPS repeaters (3) then 2D positioning can be done and GPS time can become available.

If there are four RF GPS repeaters (3), then 3D positioning can be done and GPS time can become available.

Referring to FIG. 2, every RF GPS repeaters (3) include a band pass filter (4) to reduce the noise level, a low noise amplifier (5) to amplify the GPS signal and transmission lines (T) for transmitting GPS signals from directional GPS antenna (2) to GPS antenna (6). There are also transmission lines (T) between directional GPS antennas (2) and RF GPS repeaters (3) and between RF GPS repeaters (3) and directional GPS antennas (2).

Directional GPS antenna (2) radiate greater power in specific angular directions allowing for increased performance on transmit, receive and reduce interference from unwanted sources. In indoor positioning system (1), directional GPS antennas (2a, 2b and 2c) are located outside the building (B), tunnel, mine or debris. If GPS antennas (6a, 6b and 6c) are used at outdoor instead of directional GPS antennas (2a, 2b and 2c), one GPS signal is picked up by multiple GPS antennas (6a, 6b and 6c). Thus, when these GPS signals are reradiated into the building (B), they interfere with each other inside of the building (B). Therefore, this decreases the GPS signals coverage indoors since the interfering of the GPS signals fade and form deep nulls inside the building (B). This interference also increases the error at finding the GPS receiver's (7) location. In the indoor positioning system (1), one GPS satellite (S) is only picked up by only one directional GPS antenna (2). For example; as seen in FIG. 1, directional GPS antenna (2a) picks up the GPS signal from only one GPS satellite (S1) where another directional GPS antenna (2b) picks up the GPS signal from only another GPS satellite (S4) and the other directional GPS antenna (2c) picks up the GPS signal from only the other GPS satellite (S7) due to proper design of their radiation pattern. Directional GPS antennas (2) pick up all the GPS satellite (S) signals which fall into their main beam direction. Directivity of these antennas (2a, 2b and 2c) can be chosen so that the cross GPS signal levels can be adjusted.

In this invention, directional GPS antennas (2) are used with side conical floating reflectors (C) to increase the directivities of them (2) as shown in FIG. 4. Referring to FIG. 4, a GPS antenna (6) which is placed on the ground plate (P) is used in the design of directional GPS antenna (2), and the directivity increase is achieved through the use of a conical floating reflector (C). Directional GPS antennas (2a, 2b and 2c) in this invention preferably work at 1575.42 MHz frequency with RHCP (Right Hand Circular Polarization).

Side conical floating reflectors (C) are preferably made of metal and increase the directivities of the directional GPS antennas (2). Conical floating reflector (C) does not touch to ground plate (P). Reflecting from metals to enhance the gain of the antennas is used in many antennas such as a dish antenna. Many waves arriving at the antenna are reflected from metal surfaces with co-phase to increase the signal level at the antenna. A GPS antenna (6) is used in the directional GPS antenna (2) design, and the directivity increase is achieved through the use of a conical floating reflector (C) around the GPS antenna (6). The conical floating reflector (C) is fabricated and integrated with the GPS antenna (6) and finally, performance of the directional GPS antenna (2) is measured.

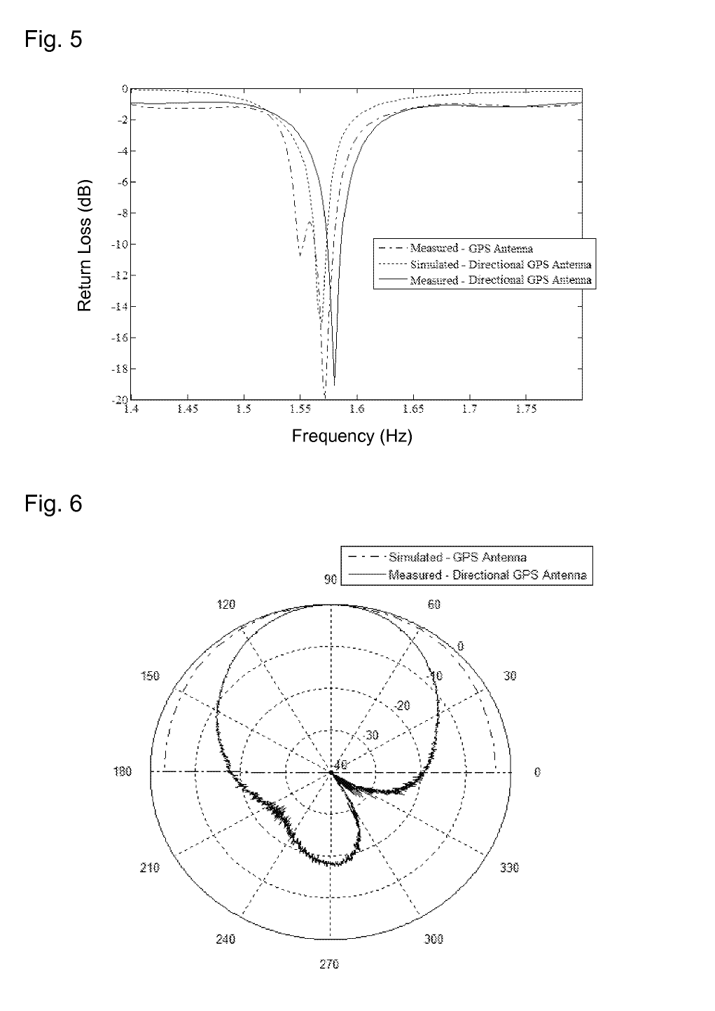

The simulated and the measured return loss of the directional GPS antenna (2) with the measured return loss of the GPS antenna (6) in this invention can be seen in FIG. 5. As seen in FIG. 5, conical floating reflector (C) changes the input impedance slightly. However, directional GPS antenna (2) still has a return loss less than 12 dB at 1575.42 MHz frequency.

RF GPS repeater (3) operates by receiving GPS signals with a directional GPS antenna (2) located outside the building (B) and reradiates those GPS signals to the indoor area or covered space. When GPS signal is received from the directional GPS antenna (2), the GPS signal is firstly filtered by band pass filter (4), after this amplified with low noise amplifier (5) and finally filtered by band pass filter (4) again and then reradiated into the building (B) by RF GPS repeater (3). After amplification, GPS signal is transmitted through the GPS antenna (6) to GPS receiver (7). A typical RF GPS repeater (3) with antennas (2, 6) is as shown in FIG. 2. RF GPS repeaters (3a, 3b and 3c) in this invention require only DC (Direct Current) power.

GPS antenna (6) receives GPS signal from RF GPS repeater (3) and transmits that GPS signal to the GPS receiver (7). Each GPS antenna (6) is well matched at frequency of related directional GPS antenna (2) and has right hand circular polarization.

The simulated and measured radiation patterns of the GPS antenna (6) and the directional GPS antenna (2) in this invention can be seen in FIG. 6.

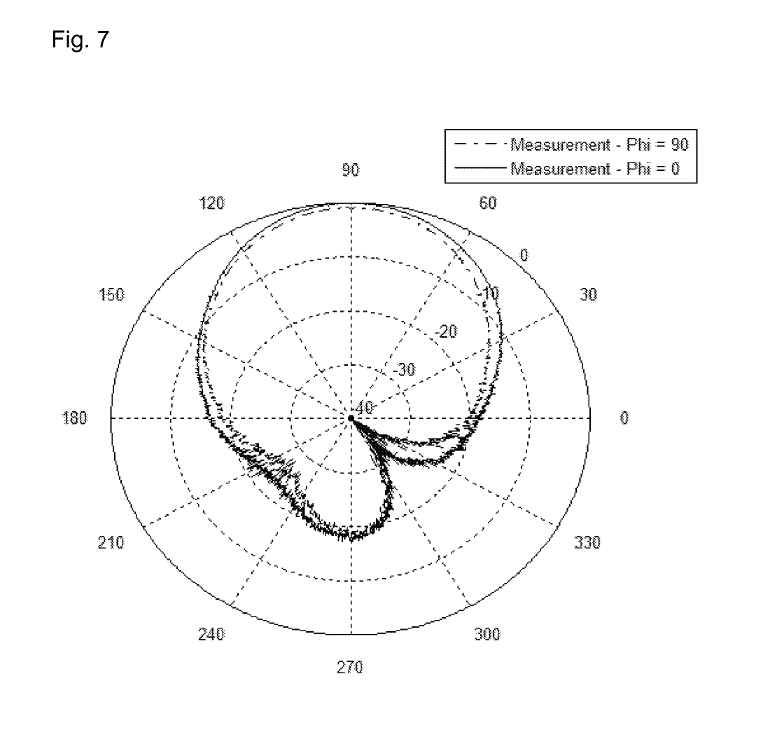

The 3 dB beam width of the directional GPS antenna (2) is 60 degrees. Gain increases when the beam width angle decreases. Decrease in the beam width angle with the conical floating reflector (C) can be easily seen in FIG. 6. Axial ratio of the directional GPS antenna (2) is measured as 1 dB which indicates that the directional GPS antenna (2) is circularly polarized at GPS frequency as shown in FIG. 7. Simulated gain of the directional GPS antenna (2) is 10 dB and the measured maximum gain of the overall system (GPS antenna (6) and the conical floating reflector (C)) is 9 dB. Simulated gain of the GPS antenna (6) is 4 dB. Conical floating reflector (C) brings an additional 5 dB gain to the GPS antenna (6).

The GPS receiver (7) picks up GPS signals coming from GPS antennas (6) by its (7) antenna (8) and calculates the positioning. In this invention, the GPS receiver (7) preferably operates at 1575.42 MHz frequency. The GPS receiver (7) in this invention also has novel position calculation method (100).

The smart way of the calculation of the location is to pick up a specific GPS signal from a prescribed direction and amplify that GPS signal from only that RF GPS repeater (3) connected to the directional GPS antenna (2). For 2D positioning, this should be repeated at least for three different GPS signals for three different RF GPS repeaters (3). This mitigates the problem of self interference for the GPS signals.

For the calculation of the GPS receiver's (7) position, the GPS receiver (7) measures the pseudo ranges (distance+clock offset+time delay) indoors. However, when GPS signals come from the GPS satellite (S), they follow the RF path: GPS satellite (S1 or S4 or S7) to the RF GPS repeater (3a or 3b or 3c) and RF GPS repeater (3a or 3b or 3c) to the GPS receiver (7) which is not a straight line as shown in FIG. 1. Since the RF path is not a straight line and also includes the RF GPS repeater (3), low noise amplifier (5), band pass filter (4), transmission lines (T) and antennas (2, 6) delays, the GPS receiver (7) using the uncorrected pseudo range measurement calculates its (7) position with an error. It is assumed that all the hardware delays in the RF GPS repeater (3) from the directional GPS antenna (2), the GPS antenna (6), the band pass filter (4), the low noise amplifier (5) and the transmission lines (T) can be priorly measured by the help of a network analyzer and calibrated out from the pseudo range measurements. In this case, if the GPS receiver (7) uses unmodified positioning calculation algorithm, it (7) tries to solve the following set of equations (Y) for 2D positioning;

R1+R4+Δt*=PR1

R2+R5+Δt*c=PR2

R3+R6+Δt*c=PR3 (Y)

where R1, R2, R3 are the distances between GPS satellite (S1 or S4 or S7) and RF GPS repeater (3a or 3b or 3c) and R4, R5 and R6 are the distances between the RF GPS repeaters (3a, 3b and 3c) and the GPS receiver (7) as shown in FIG. 1. “C” is the speed of the light and “Δt” is the GPS receiver (7) clock offset from the real GPS time and PR1, PR2, PR3 are the measured pseudo ranges of GPS satellites (S1, S4 and S7), respectively. If it is assumed that these pseudo ranges do not contain the hardware delays of the RF GPS repeaters (2), RF GPS repeaters (2) are calibrated out and the errors that stem from GPS satellites' (S) clock offsets, GPS receiver's (7) clock offset, GPS satellite (S) instrumentation delays, ionosphere effect and troposphere effects and earth rotation are removed from the equations (Y) are tried to solve by the GPS receiver (7), the position is calculated with an error since the GPS signal path from GPS satellites (S) to the GPS receiver (7) is not a straight line.

Instead, this invention proposes to solve the following equation set (Z) to mitigate this non-straight line of RF path for the positioning calculation;

R4+Δt*c=PR1−R1

R5+Δt*c=PR2−R2

R6+Δt*c=PR3−R3 (Z)

Assuming the right hand side of the equation set (Z) is known, the left hand side of the equation set (Z) specifies regular GPS distance circles originating from the RF GPS repeaters' (3a, 3b and 3c) locations. This equation set (Z) can be easily solved to find intersection of the circles and create the correct position of the GPS receiver (7). The right hand side of the equation set (Z) is also known since PR1, PR2 and PR3 are the measured pseudo ranges, and R1, R2 and R3 can easily be calculated since the RF GPS repeaters' (3a, 3b and 3c) locations are known as well as GPS satellites' (S1, S4 and S7) locations. For example, R1 can be calculated as the distance between RF GPS repeater (3a) and GPS satellite (S1).

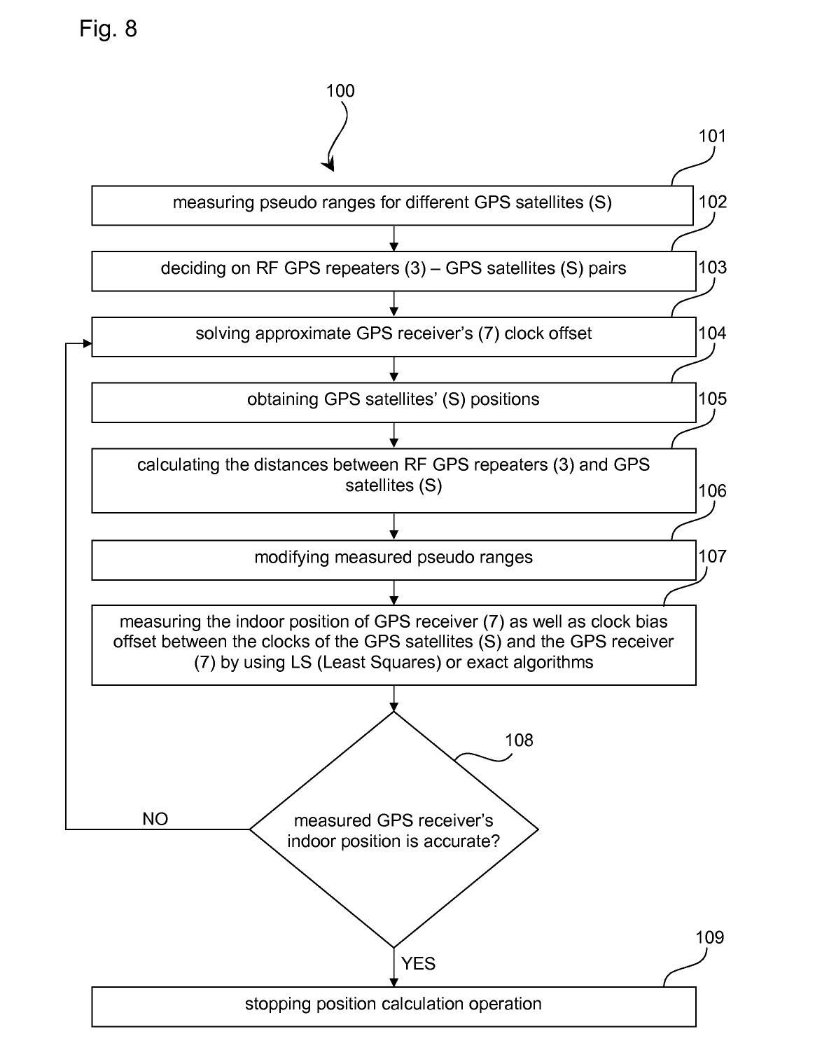

The GPS receiver's (7) position calculation method (100) includes;
measuring pseudo ranges for different GPS satellites (S) (101),
deciding on RF GPS repeaters (3)—GPS satellites (S) pairs (102),
solving approximate GPS receiver's (7) clock offset (103),
obtaining GPS satellites' (S) positions (104),
calculating the distances between RF GPS repeaters (3) and GPS satellites (S) (105),
modifying measured pseudo ranges (106),
measuring the indoor position of GPS receiver (7) as well as clock offset between the clocks of the GPS satellites (S) and the GPS receiver (7) by using LS (Least Squares) or exact algorithms (107),
examining the measured GPS receiver's (7) indoor position accuracy (108),
in the step of examining the measured GPS receiver's (7) indoor position accuracy (108) if the measured GPS receiver's (7) indoor position is not accurate, GPS receiver (7) finds place of the GPS receiver (7) and then calculates the GPS satellites' (S) positions (103) (in other words going to the step of 103),
in the step of examining the measured GPS receiver's (7) indoor position accuracy (108) if the measured GPS receiver's (7) indoor position is accurate, stopping position calculation operation (109) steps as shown in FIG. 8.

The GPS receiver (7) measures the pseudo ranges for different GPS satellites (S) coming from different RF GPS repeaters (3) (101). The GPS receiver (7) measures the pseudo ranges related to R1+R4, R2+R5 and R3+R6 distances. These pseudo ranges include GPS receiver's (7) and GPS satellites' (S) clock offset values from the real GPS time, time delay values of RF GPS repeaters (3a, 3b and 3c) and the undesired effects such as GPS satellite (S) instrumentation delays, ionosphere effect and troposphere effects and earth rotation. GPS satellites' (S) clock offset values from the real GPS time can easily be determined from GPS messages by GPS receiver (7). After finding the GPS satellites' (S) clock offset values, GPS receiver (7) adjusts GPS satellites' GPS time. The GPS receiver (7) includes a database of the positions and time delay values of the RF GPS repeaters (3a, 3b and 3c) which are caused by the band pass filters (4), low noise amplifiers (5) and transmission lines (T) inside the RF GPS repeaters (3a, 3b and 3c). RF GPS repeaters' (3a, 3b and 3c) time delay values and their (3a, 3b and 3c) positions are all measured beforehand and kept in database which is stored in the GPS receiver (7).

The GPS receiver (7) knows the position of the RF GPS repeaters (3a, 3b and 3c) from its database and also knows the angular positions of the GPS satellites (S) in ECEF (Earth-Centered, Earth-Fixed) from the GPS messages. One RF GPS repeater (3) may receive GPS signals from different GPS satellites (S). For example; as seen in FIG. 1, RF GPS repeater (3a) may receive GPS signal from two GPS satellites (S1 and S2) where another RF GPS repeater (3b) may receive GPS signal from three GPS satellites (S3, S4 and S5) and the other RF GPS repeater (3b) may receive GPS signal from the other three GPS satellites (S6, S7 and S8). The GPS receiver (7) decides which GPS signals are coming from which RF GPS repeater (3) based on the angular information of the RF GPS repeaters (3a, 3b and 3c) and the GPS signals. According to this data, GPS receiver (7) decides on RF GPS repeaters (3)—GPS satellites (S) pairs (102).

GPS receiver (7) solves approximate GPS receiver's (7) clock offset by finding its (7) approximate location with using unmodified pseudo range measurement. GPS receiver (7) firstly finds its (7) approximate location by the measured and unmodified pseudo ranges. GPS receiver (7) finds its (7) approximate GPS time by letting itself (7) to obtain a position fix with the measured and unmodified pseudo ranges and obtaining the clock offset from this approximate GPS time solution.

After solving approximate GPS receiver's (7) clock offset, GPS receiver obtains GPS satellites' (S) positions (104). GPS receiver (7) obtains GPS satellites' (S) positions according to approximate GPS time of itself (7). The exact GPS time should be known to know the exact position of the GPS satellites (S) but errors at finding GPS time do not induce a large error in the position of GPS satellites (S). For example, 1 microsecond timing error causes a distance of 300 meters of error in the GPS receiver's (7) position, however, it causes a 2.9 mm (2*π*2000 km in 12 hours, 2.9 km in 1 second, 2.9 meters in 1 millisecond and 2.9 mm in 1 microsecond) distance error in GPS satellites' (S) locations. When better positions of the GPS satellites (S) are obtained, the GPS receiver's (7) position and the clock offset can be estimated more accurately by GPS receiver (7) in an iterative manner.

The GPS receiver (7) calculates the distances between RF GPS repeaters (3) and GPS satellites (S) (105) by taking the correlation of the GPS satellite (S) code with a locally generated GPS code.

When GPS signal path (GPS satellite (S) to RF GPS repeater (3) and then RF GPS repeater (3) to the GPS receiver (7)) is determined, the GPS receiver (7) modifies measured pseudo ranges by subtracting distances between RF GPS repeaters (3) and GPS satellites (S) and undesired effects on pseudo range such as GPS receiver's (7) and GPS satellites' (S) clock offset values from the real GPS time, time delay values of RF GPS repeaters (3a, 3b and 3c) and the undesired effects such as GPS satellite (S) instrumentation delays, ionosphere effect and troposphere effects and earth rotation from the measured pseudo ranges as given in equation set (Z) (106).

R4+Δt*c=PR1−R1

R5+Δt*c=PR2−R2

R6+Δt*c=PR3−R3 (Z)

GPS satellites' (S) clock offset values from the real GPS time can easily be determined from GPS messages by GPS receiver (7). After finding the GPS satellites' (S) clock offset values, GPS receiver (7) adjusts GPS satellites' GPS time. The modified pseudo range is the pseudo range between the RF GPS repeater (3) and the GPS receiver (7) for three different GPS satellites (S).

The GPS receiver (7) measures the indoor position of itself (7) as well as clock offset by using LS or exact algorithms (107). Equation set (Z) can be solved in exact forms or intersection of three circles or intersection of two hyperbolas. Once there are three RF GPS repeaters (3) and three TOA (Time of Arrival) pseudo range measurements from the RF GPS repeaters (3) the GPS receiver (7) involves regular LS techniques or exact algorithms such as TDOA (Time Difference of Arrival) triangulation to find the indoor position of the GPS receiver (7) as well as the clock offset. Both the time and position of the GPS receiver (7) are calculated as accurate as an outdoors GPS receiver (7). TOA is used if the system components (GPS satellite (S) and the GPS receiver (7)) use the same clock, but there must be a clock offset between the GPS satellite (S) and the GPS receiver (7). By subtracting Equations (Z) from each other, the same clock offset can be eliminated and TDOA equations are obtained. If TOA equations are subtracted, TDOA equations are obtained.

The GPS receiver (7) examines the measured GPS receiver's (7) indoor position accuracy (108) by comparing the clock offset solution which is used to find GPS satellite (S) position and to remove undesired effects with the clock offset solution after positioning. GPS receiver (7) subtracts the clock offset value at the step of (107) from the clock offset value at the step of (103). After, GPS receiver (7) compares the absolute value of the difference between the clock offset value at the step of (103) and the clock offset value at the step of (103) is less then 0.1 ms or not. If the absolute value is less than 0.1 ms, GPS receiver (7) determines the measured position of itself (7) is accurate. If not, GPS receiver (7) determines the measured position of itself (7) is not accurate.

If the measured position is accurate, the GPS receiver (7) stops the position calculation operation (109).

If the measured position is not accurate, the GPS receiver (7) iteratively solves approximate GPS receiver (7) clock offset (103) by finding its (7) location.

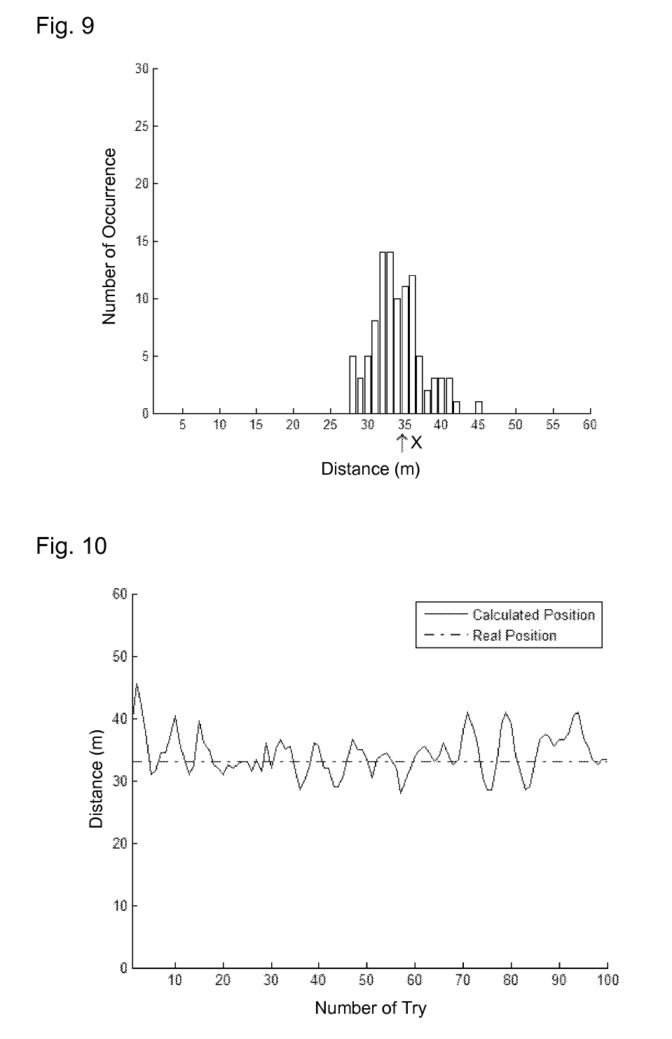

One measurement result of the position calculation method (100) results is given in FIG. 9 and FIG. 10. The GPS receiver (7) is located in the middle of the 60 meters corridor, where there is no GPS signal without the RF GPS repeater (2). When the RF GPS repeaters (2) are turned on, the position can be calculated as shown in FIG. 9 and FIG. 10. The mean of the 100 samples (10 second data) is 33 meters whereas the true position is at 33 meters from the RF GPS repeater (2).

There are other measurements performed in the same corridor, and following results are obtained as summarized in Table 1.

As seen in the Table, the mean error is less than 5 meters for all points in the corridor.

TABLE 1
Different indoor positions and Indoor GPS calculated positions

| Distance from | | | |
|---|---|---|---|
| the RF GPS | Number of | Calculated Position - | |
| repeater (2) (m) | Samples | 100 sample mean (m) | Error (m) |
| 12 | 100 | 11 | 1 |
| 12 | 100 | 9 | 3 |
| 18 | 100 | 13 | 5 |
| 18 | 100 | 15 | 3 |
| 27 | 100 | 31 | 4 |
| 33 | 100 | 34 | 1 |

Although this invention relates to global positioning systems (GPS), the concept of the increasing signal indoors can also be applied to Galileo satellites, as well as to systems where hybrid satellites from GPS and Galileo are utilized.

Within the scope of this basic concept, it is possible to develop various embodiments of the inventive an indoor positioning system (1) based on GPS signals. The invention cannot be limited to the examples described herein; it is essentially according to the claims.

### REFERENCES

[1] R. J. Fontana, E. Richley, and J. Barney, “Commercialization of an ultra wideband precision asset location system,” in Proc. IEEE Ultra Wideband Syst. Technol. Conf., Reston, Va., November 2003, pp. 369-373.
[2] S Manapure, H. Darabi, V. Patel, and P. Banerjee, “A comparative study of radio frequency-based indoor location systems,” in Proc. IEEE Int. Conf. Netw., Sens. Control, 2004, vol. 2, pp. 1265-1270.
[3] Z. Xiang, S. Song, J. Chen, H. Wang, J. Huang, and X. Gao. (2004, September/November). A WLAN based indoor positioning technology. IBM J. Res. Develop.
[4] J. Hallberg, M. Nilsson, and K. Synnes, “Positioning with Bluetooth,” in Proc. IEEE 10th Int. Conf. Telecommun., March 2003, vol. 2, pp. 954-958.
[5]Int. Conf. Netw., Sens. Control, 2004, vol. 2, pp. 1026-1041.L. M. Ni, Y. Liu, Y. C. Lau, and A. P. Patil, “LANDMARC: Indoor location sensing using active RFID,” Wireless Netw., vol. 10, no. 6, pp. 701-710,November 2004.
[6] C Drane, M. Macnaughtan, and C. Scott, “Positioning GSM telephones,” IEEE Commun. Mag., vol. 36, no. 4, pp. 46-54,59, April 1998.
[7] SYSTEM AND METHOD FOR GLOBAL POSITIONING SYSTEM REPEATER, Patent no: 200600208946 Bailey; Jenny Ann

1. An indoor global positioning system (1) comprising at least three directional GPS antennas (2a, 2b and 2c) for picking up specific GPS signals coming from at least three GPS satellites (S1, S4 and S7), at least three RF GPS repeaters (3a, 3b and 3c) for amplifying GPS signals coming from directional GPS antennas (2a, 2b and 2c), at least three GPS antennas (6a, 6b and 6c) for transmitting GPS signals coming from RF GPS repeaters (3a, 3b and 3c) to indoor, at least one GPS receiver (7) for picking up GPS signals coming from GPS antennas (6a, 6b and 6c) by its (7) antenna (8) and is characterized by position calculation method (100) for calculating the GPS time and finding positioning in two dimensions which includes the steps of;
measuring pseudo ranges for different GPS satellites (S) (101),
deciding on RF GPS repeaters (3)—GPS satellites (S) pairs (102),
solving approximate GPS receiver's (7) clock offset (103), obtaining GPS satellites' (S) positions (104),
calculating the distances between RF GPS repeaters (3)
and GPS satellites (S) (105),
modifying measured pseudo ranges (106),
measuring the indoor position of GPS receiver (7) as well as clock offset between the clocks of the GPS satellites (S) and the GPS receiver (7) by using LS (Least Squares) or exact algorithms (107),
examining the measured GPS receiver's (7) indoor position accuracy (108),
in the step of examining the measured GPS receiver's (7) indoor position accuracy (108) if the measured GPS receiver's (7) indoor position is not accurate, GPS receiver (7) finds place of the GPS receiver (7) and then calculates
the GPS satellites' (S) positions (103) (in other words going to the step of 103), in the step of examining the measured GPS receiver's (7) indoor position accuracy (108) if the measured GPS receiver's (7) indoor position is accurate, stopping position calculation operation (109).

2. The Indoor global positioning system (1) as in claim 1 characterized by RF GPS repeater (3) including a band pass filter (4) to reduce the noise level, a low noise amplifier (5) to amplify the GPS signal and transmission lines (T) for transmitting GPS signals from directional GPS antenna (2) to GPS antenna (6).

3. The indoor global positioning system (1) as in claim 1 characterized by directional GPS antennas (2) used with side conical floating reflectors (C) to increase the directivities of them (2).

4. The indoor global positioning system (1) as in claim 1 characterized by the GPS receiver (7) including a database of the positions and time delay values of the RF GPS repeaters (3a, 3b and 3c) which are caused by the band pass filters (4), low noise amplifiers (5) and transmission lines (T) inside the RF GPS repeaters (3a, 3b and 3c).

5. The indoor global positioning system (1) as in claim 4 characterized by the GPS receiver (7) knowing the position of the RF GPS repeaters (3a, 3b and 3c) from its database and also knowing the angular positions of the GPS satellites (S) in ECEF (Earth-Centered, Earth-Fixed) from the GPS messages.

6. The indoor global positioning system (1) as in claim 1 characterized by pseudo ranges including GPS receiver's (7) and GPS satellites' (S) clock offset values from the real GPS time, time delay values of RF GPS repeaters (3a, 3b and 3c) and the undesired effects such as GPS satellite (S) instrumentation delays, ionosphere effect and troposphere effects and earth rotation in the steps of measuring pseudo ranges for different GPS satellites (S) (101) and modifying measured pseudo ranges (106).

7. The indoor global positioning system (1) as in claim 1 characterized by determining GPS satellites' (S) clock offset values from the real GPS time from the GPS messages by GPS receiver (7) in the steps of measuring pseudo ranges for different GPS satellites (S) (101) and modifying measured pseudo ranges (106).

8. The indoor global positioning system (1) as in claim 1 characterized by deciding which GPS signals are coming from which RF GPS repeater (3) based on the angular information of the RF GPS repeaters (3a, 3b and 3c) and the GPS signals in the step of deciding on RF GPS repeaters (3)—GPS satellites (S) pairs (102).

9. The indoor global positioning system (1) as in claim 1 characterized by finding the approximate GPS time by letting the GPS receiver (7) to obtain a position fix with the measured and unmodified pseudo ranges and obtaining the clock offset from this approximate GPS time solution in the step of solving approximate GPS receiver's (7) clock offset (103).

10. The indoor global positioning system (1) as in claim 1 characterized by carrying out the step of obtaining GPS satellites' (S) positions (104) according to approximate GPS time of GPS receiver (7).

11. The indoor global positioning system (1) as in claim 1 characterized by carrying out the step of calculating the distances between RF GPS repeaters (3) and GPS satellites (S) (105) by taking the correlation of the GPS satellite (S) code with a locally generated GPS code.

12. The indoor global positioning system (1) as in claim 1 characterized by modifying measured pseudo ranges by subtracting distances between RF GPS repeaters (3) and GPS satellites (S) and undesired effects on pseudo range such as GPS receiver's (7) and GPS satellites' (S) clock offset values from the real GPS time, time delay values of RF GPS repeaters (3a, 3b and 3c) and the undesired effects such as GPS satellite (S) instrumentation delays, ionosphere effect and troposphere effects and earth rotation from the measured pseudo ranges as given in equation set (Z)
R4+M*c=PR1−R1
R5+M*c=PR2−R2
R6+M*c=PR3−R3 (Z)
in the step of modifying measured pseudo ranges (106) where R1, R2, R3 are the distances between GPS satellite (S1 or S4 or S7) and RF GPS repeater (3a or 3b or 3c), R4, R5 and R6 are the distances between the RF GPS repeaters (3a, 3b and 3c) and the GPS receiver (7), “C” is the speed of the light, “M” is the GPS receiver (7) clock offset and PR1, PR2, PR3 are the measured pseudo ranges of GPS satellites (S1, S4 and 87), respectively.

13. The indoor global positioning system (1) as in claim 1 characterized by solving equation set (Z) in intersection of three circles in the step of measuring the indoor position of GPS receiver (7) as well as clock offset between the clocks of the GPS satellites (S) and the GPS receiver (7) by using LS or exact algorithms (107).

14. The indoor global positioning system (1) as in claim 1 characterized by solving equation set (Z) in intersection of two hyperbolas in the step of measuring the indoor position of GPS receiver (7) as well as clock offset between the clocks of the GPS satellites (S) and the GPS receiver (7) by using LS or exact algorithms (107).

15. The indoor global positioning system (1) as in claim 1 characterized by using TDOA triangulation to find the indoor position of the GPS receiver (7) as well as the clock offset in the step of measuring the indoor position of GPS receiver (7) as well as clock offset between the clocks of the GPS satellites (s) and the GPS by using receiver (7) LS or exact algorithms (107)

16. The indoor global positioning system (1) as in claim 1 characterized by carrying out the step of examining the measured GPS receiver's (7) indoor position accuracy (108) by comparing the clock offset solution which is used to find GPS satellite (S) position and to remove undesired effects with the clock offset solution after positioning.

17. The indoor global positioning system (1) as in claim 1 characterized by carrying out the step of examining the measured GPS receiver's (7) indoor position accuracy (107) by comparing the absolute value of the difference between the clock offset value at the step of (103) and the clock offset value at the step of (107) is less then 0.1 ms or not.
